(19) United States
(12) Patent Application Publication
(10) Pub. No.: US 2026/0045602 A1
(43) Pub. Date: Feb. 12, 2026

(54) BATTERY TRAY MADE OF PLASTICS MATERIAL, COMPRISING A MOULDING COMPOUND AND A CONTINUOUS-FIBRE-REINFORCED INSERT, TOOL AND METHOD FOR PRODUCING A BATTERY TRAY, TRACTION BATTERY, AND MOTOR VEHICLE

(71) Applicant: Kautex Textron GmbH & Co. KG, Bonn (DE)

(72) Inventors: Nicolay Bergmann, Aachen (DE); Timm Heidemeyer, Koln (DE); Georg Enkirch, Salz (DE); Felix Tischer, Hammerstein (DE); Fabian Siggia, Koln (DE); Roman Bouffier, Konigswinter (DE)

(21) Appl. No.: 18/835,400

(22) PCT Filed: Aug. 11, 2022
(86) PCT No.: PCT/EP2022/072608

§ 371 Date: Aug. 2, 2024

(30) Foreign Application Priority Data
Sep. 27, 2021 (DE) 102021210758.3

(51) Int. Cl. H01M 50/121; B29C 33/12; B29C 33/42; B29C 70/08; B29C 70/18; H01M 50/103

(52) U.S. Cl. CPC H01M 50/121; B29C 33/12; B29C 33/42; B29C 70/081; B29C 70/18; H01M 50/103; H01M 2220/20

(57) ABSTRACT

The invention relates to a battery shell, in particular a battery shell of a traction battery, the battery shell being molded from a molding compound and a continuous-fiber-reinforced insert, the continuous-fiber-reinforced insert having a first surface of which greater than or equal to 50%, preferably greater than or equal to 60%, and particularly preferably greater than or equal to 75%, is not overpressed by the molding compound.

Furthermore, the invention relates to a tool for producing this battery shell and a method for producing the battery shell.

The invention also relates to a traction battery comprising said battery shell and to a motor vehicle comprising said battery shell.

This patent application claims the priority of the German patent application 10 2021 210 758.3, the disclosure of which is herewith explicitly referenced.

The invention relates to a battery shell made of plastics material, comprising a molding compound and a continuous-fiber-reinforced insert, a tool and a method for producing a battery shell, a traction battery and a motor vehicle.

In particular, the invention relates to a battery shell, in particular a battery shell of a traction battery, the battery shell being molded from a molding compound and a continuous-fiber-reinforced insert, the continuous-fiber-reinforced insert having a first surface of which greater than or equal to 50%, preferably greater than or equal to 60%, and particularly preferably greater than or equal to 75%, is not overpressed by the molding compound.

Current efforts in the automotive industry for economical series production of plastics-based lightweight components are promoting resource-optimized processes by reducing the use of fiber and semi-finished product inserts as well as the utilization of material-specific performance and cost advantages through multi-material construction. In addition, the aim is to reduce costs through component functionalization while simultaneously integrating production and reducing process steps.

The extrusion of long-fiber-reinforced thermoplastics is of great importance for the production of large-area and ribbed components. For use in structural lightweight construction applications, especially for battery shells, and the associated higher requirements with regard to component stiffness and strength, components made of long-fiber-reinforced thermoplastics must be joined to other structures in subsequent process steps.

The object of the invention is that of providing an improvement over or an alternative to the prior art.

According to a first aspect of the invention, the object is achieved by a battery shell, in particular a battery shell of a traction battery, the battery shell having a base and at least four side walls, the battery shell having an inner side and an outer side, the battery shell being molded from a molding compound and a continuous-fiber-reinforced insert, the continuous-fiber-reinforced insert having a first surface of which more than or equal to 50%, preferably more than or equal to 60% and particularly preferably more than or equal to 75%, is not overpressed by the molding compound, the continuous-fiber-reinforced insert having a second surface which is arranged opposite the first surface and of which more than or equal to 95%, preferably more than or equal to 97% and particularly preferably more than or equal to 99%, is overpressed by the molding compound.

In this regard, the following is explained conceptually:
It is first expressly noted that, in the context of the present patent application, indefinite articles and numbers such as “one,” “two,” etc., should generally be understood as being “at least” statements, i.e., as “at least one . . . ,” “at least two . . . ,” etc., unless it is clear from the relevant context or it is obvious or technically compelling to a person skilled in the art that only “exactly one . . . , ” “exactly two . . . ,”etc., can be meant.

In the context of the present patent application, the expression “in particular” should always be understood as introducing an optional, preferred feature. The expression should not be understood to mean “specifically” or “namely.”

A “battery shell” is understood to mean a housing part of a battery, in particular of a traction battery.

In particular, a battery shell for receiving components of a battery is configured and accordingly has a receiving space for receiving components so that they can be protected by the battery shell from external influences and/or can be fastened at least indirectly in the battery shell.

Preferably, a battery shell is understood to mean a lower battery shell or an upper battery shell, the lower battery shell and the upper battery shell preferably jointly producing the essential components of the housing of a traction battery.

In particular, a battery shell has a “base” and, in the preferred case of a traction battery with a substantially rectangular outline, at least four “side walls”.

The base and side walls of the battery shell form the receiving volume of a battery shell, wherein the receiving volume of the battery shell describes the “inner side”of the battery shell.

Starting from the receiving volume of the battery shell, the “outer side” of the battery shell is located on the side of the base facing away from the receiving volume and the side walls.

For a “molding compound,” in particular a plastics material should be considered, in particular a thermoplastics material or a thermosetting material which is preferably mixed with a fiber material, in particular glass fiber, carbon fiber, aramid fiber or the like.

Preferably, the molding compound, in particular if the molding compound is a polyamide, has fibers with a length of less than or equal to 15 mm, preferably fibers with a length of less than or equal to 12 mm and particularly preferably fibers with a length of less than or equal to 10 mm.

Expediently, the molding compound, in particular if the molding compound is a polypropylene, has fibers with a length of less than or equal to 35 mm, preferably fibers with a length of less than or equal to 30 mm and particularly preferably fibers with a length of less than or equal to 25 mm.

Preferably, the molding compound, in particular if the molding compound is a thermosetting SMC (sheet molding compound), has fibers with a length of less than or equal to 65 mm, preferably fibers with a length of less than or equal to 57 mm and particularly preferably fibers with a length of less than or equal to 50 mm.

Further preferably, the molding compound, in particular if the molding compound is a thermosetting SMC, has fibers with a length of more than or equal to 8 mm, preferably fibers with a length of more than or equal to 10 mm and particularly preferably fibers with a length of more than or equal to 12 mm.

The molding compound preferably comprises a polyamide, in particular a polyamide 6, a polyamide 6.6 or a polyamide 12. Furthermore, the molding compound can preferably comprise polypropylene or polycarbonate.

An “insert” is understood to mean a component that can be introduced into the battery shell during the primary shaping process to provide local stiffening of the battery shell. In other words, an insert is a stiffener which is molded together with the molding compound to form a plastics battery shell and which, in particular due to its material properties and/or its geometric orientation and/or its arrangement in or on the molding compound, is designed to at least locally stiffen the battery shell.

Preferably, an insert has a higher tensile strength than a consolidated molding compound.

Preferably, an insertion part is a semi-finished product, in particular a semi-finished product that extends at least in some regions with a constant cross-section in the main direction of extension of the insertion part.

A “continuous-fiber-reinforced insert” is understood to mean an insert which comprises continuous fibers, preferably an insert comprising continuous fibers and a matrix material made of a thermoplastic material. A matrix material made of thermoplastic material can enable the continuous-fiber-reinforced insert to be reshaped and/or an integrally bonded connection between the continuous-fiber-reinforced insert and the molding compound.

A surface of a continuous-fiber-reinforced insert is understood to be a surface which delimits the continuous-fiber-reinforced insert and which is delimited by the edges of the insert. Preferably, the first surface of an insert is understood to be one of the two surfaces of the continuous-fiber-reinforced insert that are at least approximately the same size and do not extend along the thickness of the continuous-fiber-reinforced component.

The term “overpressed” by the molding compound means that the continuous-fiber-reinforced insert has a molding compound on the relevant surface or partial surface, which preferably has run at least partially over the relevant surface during the designated molding of the battery shell. Since the flow of the molding compound requires a driving force, it is also referred to as overpressing. The driving force of the molding compound is always counteracted by a counterforce. This is also transferred, among other things, through the continuous-fiber-reinforced insert to the molding compound, at least in the areas in which a continuous-fiber-reinforced insert is adjacent to the molding compound. The effective melt pressure of the molding compound can ensure that the continuous-fiber-reinforced insert describes a flow front of the molding compound at least over part of its surface and is applied to the article cavity by the molding compound until it locally reaches an article cavity of the tool used for molding and is subsequently pressed onto it. This can advantageously result in a continuous-fiber-reinforced insert being arranged at a desired position in the battery shell by overpressing with molding compound, in particular being arranged on an edge layer of the battery shell, preferably being arranged reproducibly.

Preferably, reference is made to a surface or partial surface of the continuous-fiber-reinforced insert overpressed with molding compound if the surface or partial surface in question has a molding compound directly connected to it with a thickness of greater than or equal to 1 mm, preferably with a thickness of greater than or equal to 0.5 mm, and particularly preferably with a thickness of greater than or equal to 0.2 mm. This makes it possible, among other things, to ensure that the corresponding area is designed to be media-tight and at the same time to manage with a minimal mass fraction of molding compound.

It is known in the prior art that battery shells made of long-fiber-reinforced thermoplastics are joined to additional structures in subsequent process steps in order to achieve the required properties due to the high requirements with regard to component stiffness and strength.

By contrast, a battery shell is proposed here which has been stiffened with a continuous-fiber-reinforced insert directly during the primary shaping of the battery shell. For this purpose, the continuous-fiber-reinforced insert was integrally primary-shaped with the molding compound to form the battery shell proposed here.

One of the considerations here is that the continuous-fiber-reinforced insert has a thermoplastic matrix material so that the continuous-fiber-reinforced insert can be shaped under the influence of the melt temperature and the melt pressure of the molding compound, among other things.

The continuous-fiber-reinforced insert is designed to stiffen the battery shell. The stiffening is based, among other things, on the material properties of the continuous-fiber-reinforced insert and/or the orientation of the continuous-fiber-reinforced insert, in particular the contour-accurate orientation of the continuous-fiber-reinforced insert with only a minimum of folds and/or dents, if any, and/or the interaction of the continuous-fiber-reinforced insert with the battery shell.

Preferably, the continuous-fiber-reinforced insert is completely surrounded by the molding compound in a first partial region and arranged adjacent to the molding compound in a second partial region. In this way, a form fit between the molding compound and the continuous-fiber-reinforced insert can be achieved in the first partial area.

Preferably, the plastics material of the molding compound and the plastics material of the continuous-fiber-reinforced insert are materially compatible to such an extent that they can form an integrally bonded connection with one another, whereby a particularly rigid design of the battery shell and/or a particularly high durability of the battery shell can be achieved. In this case, it can still be achieved that the battery shell is molded monolithically.

According to a preferred embodiment, the continuous-fiber-reinforced insert has a first surface of which more than or equal to 55%, preferably more than or equal to 66%, and particularly preferably more than or equal to 70% is not overpressed by the molding compound. Likewise advantageously, the continuous-fiber-reinforced insert has a first surface of which more than or equal to 80%, preferably more than or equal to 85%, and particularly preferably more than or equal to 90% is not overpressed by the molding compound. Furthermore advantageously, the continuous-fiber-reinforced insert has a first surface of which more than or equal to 92.5%, preferably more than or equal to 95%, and particularly preferably more than or equal to 97.5% is not overpressed by the molding compound.

It should be explicitly pointed out that the above values for the proportion of the first and/or second surface of the continuous-fiber-reinforced insert overpressed by the molding compound should not be understood as strict limits; rather, it should be possible to exceed or fall below them on an engineering scale without departing from the described aspect of the invention. In simple terms, the values are intended to provide an indication of the magnitude of the proportion of the first and/or second surface of the continuous-fiber-reinforced insert that is overpressed by the molding compound, as proposed here.

The aspect proposed here can advantageously ensure that the battery shell stiffened with a continuous-fiber-reinforced insert can be produced particularly efficiently and reproducibly, in particular without having to apply a continuous-fiber-reinforced insert in a separate process step after the molding compound has been molded. A further advantage of the battery shell proposed here is the high positioning accuracy of the continuous-fiber-reinforced insert, which can improve the reproducible production of the battery shell.

Furthermore, it can be achieved in a particularly advantageous manner that the continuous-fiber-reinforced insert can be arranged at least partially directly on the surface of the battery shell, whereby a contour-accurate precision of the arrangement of the continuous-fiber-reinforced insert can be achieved. This can prevent unwanted dents and/or folds in the continuous-fiber-reinforced insert in the battery shell or at least reduce them compared to the prior art.

Overall, a battery shell can be achieved which has a continuous-fiber-reinforced insert arranged in a load-path-appropriate and reproducible manner to stiffen the battery shell.

It is also proposed that the second surface opposite the first surface of the continuous-fiber-reinforced insert is predominantly overpressed with molding compound.

This can, among other things, improve the reproducible arrangement of the continuous-fiber-reinforced insert in the battery shell.

Furthermore, the large contact area between the second surface of the continuous-fiber-reinforced insert and the molding compound means that a particularly stable force transmission between the molding compound and the continuous-fiber-reinforced insert can be achieved.

The area of the second surface of the continuous-fiber-reinforced insert proposed here, which is overpressed with molding compound, enables, among other things, the design of more complex and/or thicker geometries of the battery shell. Among other things, this makes it possible to better integrate functional elements into the battery shell.

Furthermore, this makes it possible for an area at least partially surrounded by a continuous-fiber-reinforced insert to accommodate a desired complex geometry, in particular a stiffening rib structure, in particular a rib structure of an inner stiffening means.

Preferably, it can be achieved, in particular by the second surface of the continuous-fiber-reinforced insert being at least largely overpressed with molding compound, that the battery shell proposed here is media-tight. An organosheet is not necessarily media-tight, but by back-pressing an organosheet, media-tightness of the relevant area can be achieved.

It should be expressly pointed out that a battery shell can also have a plurality of continuous-fiber-reinforced inserts, in particular two continuous-fiber-reinforced inserts, three continuous-fiber-reinforced inserts, four continuous-fiber-reinforced inserts, five continuous-fiber-reinforced inserts, six continuous-fiber-reinforced inserts, seven continuous-fiber-reinforced inserts, eight continuous-fiber-reinforced inserts, nine continuous-fiber-reinforced inserts and so on. One idea is that a plurality of continuous-fiber-reinforced inserts are arranged adjacent to one another. Alternatively, it could be considered that continuous-fiber-reinforced inserts are arranged in different areas.

Furthermore, it is preferably proposed here, among other things, that the battery shell has functional elements. Functional elements include, among other things, connecting means which establish a connection between the battery shell and components of the designated traction battery and/or the designated motor vehicle. Among other things, a connecting means is envisaged which has a hollow space, in particular an internal thread, which is formed in the area of the continuous-fiber-reinforced insert.

Furthermore, functional elements also include fluid lines that are formed in the battery shell.

According to a preferred embodiment, the continuous-fiber-reinforced insert comprises an organosheet and/or a tape fabric.

In this regard, the following is explained conceptually:
An “organosheet” is understood to mean a fiber composite material comprising continuous fibers, in particular continuous fibers with a fiber length of more than or equal to 40 mm, and a thermoplastic material. Preferably, the continuous fibers are oriented unidirectionally. Furthermore, an organosheet preferably comprises a woven fabric or scrim of continuous fibers which are wetted with a thermoplastic matrix material.

A “tape fabric” is a fabric made of unidirectionally oriented continuous fibers which are wetted with a thermoplastic matrix material.

It is proposed here that a continuous-fiber-reinforced insert comprises or consists of an organosheet and/or a tape fabric.

This has the advantage that the continuous-fiber-reinforced insert can be constructed from readily available components, which can also be processed efficiently.

According to a particularly expedient embodiment, the continuous-fiber-reinforced insert is shaped from a single plane.

In this regard, the following is explained conceptually:
A continuous-fiber-reinforced insert “shaped from a single plane” is understood to have a three-dimensional geometry that does not extend flat. In particular, a continuous-fiber-reinforced insert which originally had a flat geometry prior to the molding of the battery shell is shaped in such a way that it no longer has a flat geometry after the molding. In other words, the continuous-fiber-reinforced insert protrudes from a flat plane. The continuous-fiber-reinforced insert has a tool-dependent non-planar geometry prescribed by the designated tool for producing the battery shell.

Preferably, a flat plane is understood to mean a flat geometry with a finite thickness, preferably with a thickness of less than or equal to 10 mm, more preferably with a thickness of less than or equal to 5 mm, and particularly preferably with a thickness of less than or equal to 2 mm. Accordingly, a continuous-fiber-reinforced insert can also be shaped in a plane which has relatively minor dents and/or folds, but the overall geometry of which extends in the protruding thickness of a flat geometry.

Advantageously, the rigidity can be increased by a continuous-fiber-reinforced insert shaped from a plane, in particular since the continuous-fiber-reinforced insert shaped from a plane has a larger area moment of inertia, at least with respect to one axis, than a flat continuous-fiber-reinforced insert.

Optionally, the continuous-fiber-reinforced insert has at least a first leg and a second leg in a cross-section to its main direction of extension, wherein the first leg and the second leg are connected to one another, wherein the first leg and the second leg have an angle of less than or equal to 100° to one another, preferably an angle of less than or equal to 50° and particularly preferably an angle of less than or equal to 30°.

In this regard, the following is explained conceptually:
The “main direction of extension” of the continuous-fiber-reinforced insert is preferably understood to mean the direction in which the continuous-fiber-reinforced insert substantially retains its cross-section. Preferably, the main direction of extension means the longitudinal direction of extension of the continuous-fiber-reinforced insert.

A “leg” is understood to mean a partial area of a continuous-fiber-reinforced insert which extends substantially in a straight line, at least in some areas. Preferably, a leg is understood as a partial region of the continuous-fiber-reinforced insert arranged at least at one end, wherein the leg extends substantially in a straight line.

Preferably, it is envisaged that a first leg of the continuous-fiber-reinforced insert is connected indirectly via the molding compound or directly to a second leg of the continuous-fiber-reinforced insert.

Preferably, the first and second legs are not aligned parallel to each other, so that the straight extension of the legs leads to a vertex, which the continuous-fiber-reinforced insert does not have to include. Possible considerations here include, among other things, a V-shaped or a U-shaped cross-section of a continuous-fiber-reinforced insert; in particular, two legs can merge into one another by means of a differentiable curvature or a kink. An angle between the legs can be determined by the straight-line extension of the legs and the vertex formed.

The course of the legs allows a geometric alignment of the continuous-fiber-reinforced insert to be achieved, which results in advantageous stiffening of the battery shell.

Preferably, a leg has a leg length encompassed by the continuous-fiber-reinforced insert which is more than or equal to 1 cm, preferably more than or equal to 2 cm, and particularly preferably more than or equal to 3 cm. Furthermore, a leg preferably has a leg length encompassed by the continuous-fiber-reinforced insert which is more than or equal to 5 cm, preferably more than or equal to 7 cm, and particularly preferably more than or equal to 10 cm.

A first leg can preferably have a leg length encompassed by the continuous-fiber-reinforced insert which is greater than or equal to the leg length of the second leg encompassed by the continuous-fiber-reinforced insert.

A continuous-fiber-reinforced insert can also have more than two legs, in particular three legs, four legs, five legs and so on. Here, too, it should be considered that these are connected to each other indirectly via the molding compound or directly. Furthermore, adjacent legs preferably form a vertex through the intersection of their straight-line extensions. Among other things, a continuous-fiber-reinforced insert is considered here, which extends by means of more than two legs from the bottom of the battery shell into an inner stiffening means. A continuous-fiber-reinforced insert with at least four or five legs can have an omega-shaped cross-sectional shape, wherein the legs delimiting the continuous-fiber-reinforced insert on both sides can preferably be arranged in the base of the battery shell.

Even if there are more than two legs of the continuous-fiber-reinforced insert, indirectly or directly adjacent legs of the continuous-fiber-reinforced insert can be connected to one another directly or indirectly via the molding compound.

Preferably, among other things, it should also be considered that two legs are aligned parallel to each other and are connected to each other indirectly via the molding compound or directly.

Expediently, the first leg and the second leg have an angle of greater than or equal to 5° to one another, preferably an angle of greater than or equal to 10°, and particularly preferably an angle of greater than or equal to 15°.

In this way, a local stiffening of the battery shell can be advantageously achieved, which requires a comparatively small installation space.

Particularly preferably, the continuous-fiber-reinforced insert has at least one recess.

In this regard, the following is explained conceptually:
A “recess” is understood to mean an area at least partially surrounded by the continuous-fiber-reinforced insert, in particular an area completely surrounded by the continuous-fiber-reinforced insert. In other words, a recess means an aperture and/or an opening in the continuous-fiber-reinforced insert, i.e., an area that does not have a continuous fiber.

Preferably, a recess has been produced by punching out the continuous-fiber-reinforced insert at the location of the recess.

Advantageously, a recess can be used to arrange a functional element, in particular a functional element that is at least partially hollow, in the region of the continuous-fiber-reinforced insert, in particular a functional element of which the hollow region extends through the plane of the continuous-fiber-reinforced insert.

For example, a recess can be used to ensure that molding compound can flow through the recess in the continuous-fiber-reinforced insert during the designated molding of the battery shell, and thus areas adjacent to the first surface of the continuous-fiber-reinforced insert can also be molded with molding compound. In other words, a recess in the continuous-fiber-reinforced insert enables a battery shell, which on the one hand has a load-path-appropriate integration of a continuous-fiber-reinforced insert and at the same time can have a functional element which is arranged on the first surface of the continuous-fiber-reinforced insert and/or the hollow region of which can penetrate the plane of the continuous-fiber-reinforced insert.

A recess can thus also serve as a flow aid for the molding compound when molding the battery shell and allows an additional geometric degree of freedom in the shaping of the battery shell, which can be particularly useful for additional local stiffeners, functional elements and/or an improvement in the form fit between the continuous-fiber-reinforced insert and the molding compound.

The continuous-fiber-reinforced insert expediently has a rib immediately adjacent to its first surface.

In this regard, the following is explained conceptually:
A “rib” is understood to mean a local material elevation which is adjacent to the continuous-fiber-reinforced insert and which is immediately adjacent to the first surface of the continuous-fiber-reinforced insert.

Preferably, a rib is provided for locally stiffening a region of the battery shell which has the continuous-fiber-reinforced insert, in particular a region which interacts with a functional element and/or which is directly or indirectly connected to a functional element.

A functional element is understood to mean, among other things, a connecting element through which external loads can be introduced into the battery shell.

Preferably, the cross-section of the rib comprises molding compound or is filled with the molding compound. This also makes it possible for molding compound to flow through the cross-section of the rib during the designated production of the battery shell, whereby the first surface of the continuous-fiber-reinforced insert can be partially overpressed by molding compound and can form a rib. Furthermore, the molding compound flowing through the cross-section of the rib during the designated production of the battery shell can form a functional element which is adjacent to the rib and which is arranged adjacent to the first surface of the continuous-fiber-reinforced insert.

Further advantageously, a rib can be used to improve the form fit between the continuous-fiber-reinforced insert and the molding compound.

Preferably, the continuous-fiber-reinforced insert comprises a transverse rib at least partially with its second surface.

In this regard, the following is explained conceptually:
A “transverse rib” is understood to mean a slim, rib-shaped continuation of the molding compound that runs at least partially transversely to the main direction of extension of the continuous-fiber-reinforced insert, in particular transversely to the main direction of extension of the continuous-fiber-reinforced insert, which is at least partially encompassed by the continuous-fiber-reinforced insert and which is designed to additionally stiffen the region in which the continuous-fiber-reinforced insert is arranged, in particular to prevent or reduce a transverse contraction of the region.

Specifically, a plurality of transverse ribs are also conceivable which can be arranged at regular or irregular intervals.

Preferably, transverse ribs are arranged in pairs, wherein a transverse rib is further preferably formed on both sides of the region comprised by the continuous-fiber-reinforced insert with the same value of the longitudinal extension of the continuous-fiber-reinforced insert.

Optionally, the continuous-fiber-reinforced insert is arranged in an inner stiffening element of the battery shell.

In this regard, the following is explained conceptually:
An “inner stiffening means” is understood to mean a geometric configuration of the battery shell on the inner side of the battery shell which is configured to stiffen the battery shell.

Preferably, an inner stiffening means is a rib. A rib is understood to mean a geometry exhibited in the interior of the battery shell and configured to stiffen the battery shell.

Preferably, a rib is a longitudinal rib, where a longitudinal rib extends in the longitudinal direction of the battery shell and is configured to increase at least one area moment of inertia, particularly preferably two area moments of inertia, of a cross section of the battery shell running normal to the longitudinal direction, so that the battery shell is stiffened.

Preferably, a rib is a transverse rib, wherein a transverse rib extends in the transverse direction of the battery shell and is configured to increase at least one area moment of inertia, particularly preferably two area moments of inertia, of a cross-section of the battery shell running normal to the transverse direction, so that the battery shell is stiffened.

Preferably, a rib is arranged such that it is configured as a spatial separation between two designated adjacent battery cells and/or battery modules. Particularly preferably, a battery module can be fastened to an inner stiffening means, further preferably a battery module is carried by an inner stiffening means.

An inner stiffening means preferably has at least one longitudinal rib and at least one transverse rib. Preferably, the at least one longitudinal rib and the at least one transverse rib are connected to one another.

Furthermore, an inner stiffening means is preferably provided, which divides a receiving space of the battery shell arranged on the inner side of the battery shell in a transverse and/or a longitudinal main direction of extension, in particular divides it centrally.

As a result, it can be achieved that the continuous-fiber-reinforced insert particularly advantageously can be introduced into the battery shell in a load-path-appropriate manner, wherein at the same time the available installation space, for example in a separating rib arranged between the designated battery modules, can be utilized.

A continuous-fiber-reinforced insert is also expediently arranged in an outer stiffening means of the battery shell.

In this regard, the following is explained conceptually:
An “outer stiffening means” is understood to mean a geometric configuration of the battery shell on the outer side of the battery shell and/or a material change of the battery shell which is configured to stiffen the battery shell.

An outer stiffening means is preferably configured to stiffen the base of the battery shell and/or at least one side wall of the battery shell.

Preferably, an outer stiffening means is intended to mean a profile of at least one side wall of the battery shell, wherein the profiling of the at least one profiled side wall of the battery shell increases at least one area moment of inertia of the at least one profiled side wall of the battery shell, particularly preferably two area moments of inertia of the at least one profiled side wall of the battery shell, relative to a side wall of a battery shell without profiling and with comparable wall thickness and comparable material composition.

A profiling is intended preferably to mean an I-profile, a U-profile, a T-profile, a Z-profile, an L-profile, a profile cumulatively composed from the previously mentioned profiles or a different profiling.

It should be expressly noted that a profiling can be understood to mean any geometric change relative to a planar extension of at least one side wall and/or the base of the battery shell.

It should be expressly pointed out that the aspect of an outer stiffening means presented here is not limited to a stiffening of one side wall of the battery shell, rather, even two or more side walls of the battery shell, preferably all of the side walls of the battery shell, can have an outer stiffening.

It should be expressly noted that a side wall can represent a component of an outer stiffening means.

Advantageously, as a result a continuous-fiber-reinforced insert can be arranged as a local stiffening measure in a particularly advantageous region of the battery shell. In most applications, the outer stiffening means is used to fasten the battery shell to the designated motor vehicle, so that this alone places greater loads on the battery shell. In addition, a region of the battery shell that is exposed to high external loads in the event of a side pole impact can be stiffened in this way.

Particularly preferably, the continuous-fiber-reinforced insert is arranged on the inner side of the battery shell, in particular the continuous-fiber-reinforced insert is arranged with the first surface of the continuous-fiber-reinforced insert on the inner side of the battery shell.

Preferably, a continuous-fiber-reinforced insert is arranged directly adjacent to the receiving space of the battery shell.

This advantageously allows the geometric installation space to be used to the maximum to increase the area moment of inertia emanating from the continuous-fiber-reinforced insert. In particular, an optimal edge fiber spacing can be achieved. Overall, this improves the stiffening of the battery shell provided by the continuous-fiber-reinforced insert.

The battery shell is conveniently molded using a compression-molding process.

In this regard, the following is explained conceptually:
A “compression-molding process” is understood to mean a primary shaping process in which the molding compound is introduced into the cavity of an associated compression mold in a first step, with the compression mold being closed in a second step, in particular using a pressure piston. By closing the compression mold, the molding compound acquires the shape specified by the compression mold, in particular the shape of the article cavity of the compression mold. The compression mold is preferably temperature-controlled.

In particular, a compression-molding process can also be understood as a direct compounding process, in which a fiber material is fed into an extruder, where it is impregnated with the already melted matrix polymer, in particular a thermoplastics material or a thermosetting material, and is transferred into an injection piston and is then introduced into the compression mold as a molding compound.

Advantageously, an established production process for the battery shell proposed here can thus be used, as a result of which costs can be saved and the process risk of the production process can be minimized.

Furthermore, compared to an injection molding process, less fiber damage can be achieved during plasticizing and pressing, which makes it possible for longer average fiber lengths and thus better mechanical properties to be achieved in the battery shell.

Preferably, the battery shell has at least one linearly extending indentation, preferably a linearly extending indentation on the inner side of the base.

In this regard, the following is explained conceptually:
A “linearly extending indentation” is a hollow shape in the relief of the surface of the battery shell. Preferably, an indentation in the cross-section arranged orthogonally to the main direction of extension has a concave and/or convex depression in the surface of the battery shell. Preferably, an indentation can have a plurality of spatial curvatures.

In the region of the indentation, the material thickness of the molding compound of the battery shell may decrease.

Preferably, a linearly extending indentation is arranged adjacent to an inner and/or outer stiffening means. Preferably, the main direction of extension of the indentation extends orthogonally to the main direction of extension of an inner and/or outer stiffening means.

Preferably, the battery shell has a plurality of linearly extending indentations, wherein these can be arranged in pairs on both sides of an inner stiffening means.

According to a particularly expedient aspect, the insert has a chamfer, preferably two chamfers.

In this regard, the following is explained conceptually:
A “chamfer” is a beveled surface on a first edge of the insert. A chamfer can have an angle of greater than or equal to 20°, preferably an angle of greater than or equal to 30°, further preferably an angle of greater than or equal to 40° and particularly preferably an angle of greater than or equal to 50°. A chamfer can have an angle of less than or equal to 70°, preferably an angle of less than or equal to 60°, more preferably an angle of less than or equal to 50° and particularly preferably an angle of less than or equal to 40°.

Preferably, the insert has a chamfer on the designated edge of the insert facing away from the article cavity and/or the surface of the battery shell.

The chamfer can extend over a thickness of greater than or equal to 20% of the thickness of the insert, preferably over a thickness of greater than or equal to 40% of the thickness of the insert, further preferably over a thickness of greater than or equal to 60% of the thickness of the insert, and particularly preferably over a thickness of greater than or equal to 80% of the thickness of the insert.

The beveled surface of the chamfer can coincide with a second edge, wherein the second edge is arranged adjacent to the first edge. As a result, the insert can end at least on one side in a sharp edge, wherein the sharp edge has an opening angle of less than or 70°, preferably an opening angle of less than or 50° and particularly preferably an opening angle of less than or 30°.

At the closing of the tool, the molding compound flows over the insertion part with a moving flow front, as a result of which the position of the insert can change or the structure of the insert can be damaged.

The chamfer can be configured to interact with a flow front of the molding compound during the molding of the battery shell, in particular by the specific design of the end of the insert that first comes into contact with the flow front, in particular by a chamfer on an edge of the insert. For example, an edge designated by the flow front of the molding compound for being flowed around at an angle can have a chamfer and thus a beveled surface. As a result, it can be achieved that the flow resistance acting on the molding compound from the insert can be reduced and/or smaller forces can be transferred from the molding compound to the insert, as a result of which any structural damage to the insert can be reduced or prevented. Furthermore, as a result it can be achieved that the compressive force transferred from the molding compound to the insert has a component that runs normal to the beveled surface. Among other things, this enables the insert to be pressed against the article cavity of the tool by the molding compound, as a result of which a reproducible arrangement of the insert in the battery shell can be achieved.

Furthermore, the insert can preferably have a chamfer at opposite ends of the insert in a transverse direction to its main direction of extension, in particular at the edge of the insert facing away from the article cavity and/or the surface of the battery shell. This can help to position the insert on the inner side of the battery shell, especially when the insert is overpressed with molding compound on both sides. Furthermore, the beveled surfaces arranged on both sides of the article cavity can interact with the molding compound to ensure that the edge facing the article cavity can be pressed by the molding compound onto the article cavity and/or the designated surface of the battery shell, whereby a reproducible arrangement of the entire insert can be achieved.

According to a second aspect of the invention, the object is achieved by a tool for producing a battery shell according to the first aspect of the invention, in particular a compression mold, wherein the tool forms an article cavity, wherein the tool preferably has a means for filling the article cavity with a molding compound.

In this regard, the following is explained conceptually:
A “tool” is understood to mean a device for primary shaping, in particular for primary shaping of a battery shell according to the first aspect of the invention from a molten molding compound and at least one continuous-fiber-reinforced insert.

A tool is preferably understood to mean a compression mold, in particular an injection compression mold.

Preferably, a tool is understood to mean a tool station, in particular a tool station which, in addition to an article cavity and/or a means for filling the tool, comprises further functional elements, in particular a manipulator system and/or a heating device.

An “article cavity” is understood to mean the hollow space which is formed by a tool for forming regions of the component that is designated to be produced with the tool, in particular a battery shell.

A “means for filling” is understood to mean a device which is indirectly or directly assigned to the tool and is configured to introduce a molten molding compound into the tool. Alternatively, the molding compound can also be manually introduced into the opened article cavity.

Preferably, a means for filling is understood to mean a device by means of which a molten molding compound can be introduced, in particular can be inserted, into a previously opened tool, in particular in conjunction with a pressing tool and/or a pressing device.

Preferably, a means for filling the article cavity with molding compound is designed to deposit the molding compound directly on a previously inserted continuous-fiber-reinforced insert.

Here, a tool for producing a battery shell according to the first aspect of the invention is proposed.

It should be understood that the previously explained advantages of a battery shell according to the first aspect of the invention extend to a tool for producing a battery shell according to the first aspect of the invention.

According to a particularly preferred embodiment, the tool has a local elevation in the article cavity, in particular a plurality of mutually corresponding local elevations, which are designed for the partial surface deposit of the continuous-fiber-reinforced insert in the article cavity.

In this regard, the following is explained conceptually:
A “local elevation” is understood to mean a local increase in the relief of the surface of the article cavity.

Preferably, a local elevation is a concave and/or convex increase in the surface of the article cavity; preferably, a local elevation can have a plurality of spatial curvatures. According to a preferred embodiment, the geometry of a local elevation corresponds to a segment of a sphere.

In other words, a local elevation is designed so that a continuous-fiber-reinforced insert does not have to be deposited over the entire surface of the article cavity, whereby a heat flow between the article cavity and the continuous-fiber-reinforced insert can be reduced, since the continuous-fiber-reinforced insert can be supported predominantly at a distance from the wall of the article cavity adjacent to the local elevation. In this respect, this is also referred to as “partial deposition.”

In this context, “deposition” means that the continuous-fiber-reinforced insert is supported in a manner that is at least statically determined by the local elevation(s).

The term “mutually corresponding local elevations” means a plurality of local elevations which are jointly arranged so that a continuous-fiber-reinforced insert can be deposited on them.

Preferably, mutually corresponding local elevations are intended to mean webs which are arranged parallel to one another in the article cavity and which preferably have at least predominantly a horizontal course.

Among other things, this can advantageously prevent or reduce the risk of a heated continuous-fiber-reinforced insert cooling down too much due to contact with the tool, in particular with the tool which has a lower temperature than the continuous-fiber-reinforced insert. In particular, this makes it possible for the continuous-fiber-reinforced insert to be reshapeable and/or to form an integrally bonded connection with the molding compound.

The tool expediently has a positioning means which is designed to position the continuous-fiber-reinforced insert in the tool.

In this regard, the following is explained conceptually:

A “positioning means” is understood to mean a means which is designed to center the continuous-fiber-reinforced insert in the article cavity and/or to prevent or reduce an unwanted slipping movement of the continuous-fiber-reinforced insert in the article cavity.

According to a preferred embodiment, a positioning means is understood to mean an end stop and/or an edge stop, in particular a plurality of stops which are arranged correspondingly on several sides of the continuous-fiber-reinforced insert.

Preferably, a positioning means is embodied in the form of a local elevation in the article cavity. In this context, it should also be considered, among other things, that a local elevation for depositing the continuous-fiber-reinforced insert merges on one side into a positioning means, wherein an elevation height of the positioning means is higher than an elevation height of the corresponding local elevation.

Advantageously, this can prevent or reduce displacement of the continuous-fiber-reinforced insert due to depositing or introducing the molding compound.

Preferably, the tool has a temperature-control system for controlling the temperature of the tool.

In this regard, the following is explained conceptually:
A “temperature-control system” is a device which is designed to control the temperature of the tool, in particular by cooling and/or heating the tool.

Preferably, a temperature-control system is designed to keep the temperature of the tool above 80° C.

This can advantageously improve the surface quality of the battery shell and/or improve the positioning of the continuous-fiber-reinforced insert and/or shorten the cycle time when molding a battery shell.

Particularly expediently, the tool has a preforming tool, wherein the preforming tool is designed to preform the continuous-fiber-reinforced insert.

In this regard, the following is explained conceptually:
A “preforming tool” is a tool which is designed to preform the continuous-fiber-reinforced insert. Preferably, the preforming tool is configured to preform the continuous-fiber-reinforced insert before insertion into the article cavity or after insertion into the article cavity. Preferably, a preforming tool has one or more slides, which are further preferably actively controlled and/or can perform a predominantly vertical movement.

It should be remembered here that the exact shaping of the continuous-fiber-reinforced insert and with it the battery shell is carried out by the tool core that forms the article cavity. The tool core can be designed in such a way that the preformed insert is partially covered with molding compound, in particular for forming a rib.

Preferably, the preforming tool is a component of the tool, wherein the preforming tool can be moved at least in regions relative to at least a part of the tool in order to enable preforming of the continuous-fiber-reinforced insert.

Among other things, it should be remembered that the preforming tool is hydraulically mounted, in particular is hydraulically mounted in a part of the tool.

The preforming tool can be designed to preform the continuous-fiber-reinforced insert only over a part of its longitudinal extension or alternatively over its entire longitudinal extension. Furthermore, a preforming tool is considered which interacts directly with the continuous-fiber-reinforced insert or alternatively at least partially interacts with the molding compound, which in turn deforms the continuous-fiber-reinforced insert.

This can advantageously improve the positioning accuracy of the continuous-fiber-reinforced insert and thus the reproducibility in the designated production of the battery shell.

Particularly preferably, the tool has a local depression in the article cavity, wherein the local depression is configured to form a rib of the battery shell.

In this regard, the following is explained conceptually:
A “local depression” in the article cavity of the tool is understood to mean a hollow shape in the relief of the surface of the article cavity, wherein the local depression is designed to form a rib of the battery shell.

Advantageously, a battery shell having a rib can be formed in this way, wherein the previously explained advantages of the battery shell are transferred to the tool claimed here.

Furthermore, the tool preferably has a transverse rib recess, wherein the transverse rib recess is configured to form a transverse rib of the battery shell.

In this regard, the following is explained conceptually:
A “transverse rib recess” is understood to mean a geometry of the article cavity which is designed to form a transverse rib in the battery shell, in particular a transverse rib which is at least partially enclosed by the continuous-fiber-reinforced insert.

The transverse rib recess presented here allows a battery shell having a transverse rib to be formed, so that the already explained advantages of a transverse rib are transferred to the tool proposed here.

Optionally, the tool has a manipulator or is configured to interact with a manipulator, wherein the manipulator is configured to deposit the continuous-fiber-reinforced insert in the article cavity.

In this regard, the following is explained conceptually:
A “manipulator” is a device that enables physical interactions with its environment, wherein the manipulator is configured to perform mechanical work.

Preferably, a manipulator has at least one axis with an associated drive unit.

This advantageously makes it possible to automatically place a continuous-fiber-reinforced insert in the article cavity of the tool with high accuracy and in a reproducible manner.

The tool expediently has a heating device or is configured to interact with a heating device, wherein the heating device is configured to heat the continuous-fiber-reinforced insert.

In this regard, the following is explained conceptually:
A “heating device” is understood to mean a device which is configured to heat the continuous-fiber-reinforced insert, in particular to heat it to a temperature above the melting temperature of the matrix material of the continuous-fiber-reinforced insert, in particular to a temperature above 200° C.

A heating device is preferably understood to mean an infrared emitter.

This advantageously allows the continuous-fiber-reinforced insert to be heated before and/or after it is introduced into the article cavity, which allows it to be better reshaped and/or to form an integrally bonded connection with the molding compound.

It should be expressly noted that the subject matter of the second aspect can advantageously be combined with the subject matter of the preceding aspect of the invention, both individually or cumulatively in any combination.

According to a third aspect of the invention, the object is achieved by a method for producing a battery shell according to the first aspect of the invention, in particular using a tool according to the second aspect of the invention, wherein the method for producing the battery shell comprises the following steps:
a) inserting the continuous-fiber-reinforced insert into the opened article cavity;
b) introducing the molding compound into the article cavity;
c) molding the battery shell;
d) demolding the battery shell.

In this regard, the following is explained conceptually:
The term “inserting” the continuous-fiber-reinforced insert into the article cavity is understood to mean in particular the inserting and/or depositing and/or introducing of the continuous-fiber-reinforced insert into the article cavity.

Here, a method is proposed for the process-integrated production of a highly stressed battery shell by at least partially combined reshaping and encapsulation of a continuous-fiber-reinforced insert with a molding compound, whereby an efficient and reproducible battery shell can be directly connected to a continuous-fiber-reinforced insert in an integrally bonded and/or form-fitting manner during the primary shaping. The continuous-fiber-reinforced insert can thus be integrated locally into the battery shell in a load-path-appropriate manner.

It should be understood that the advantages of a battery shell according to the first aspect of the invention and/or the advantages of a tool according to the second aspect of the invention, extend to a method for producing a battery shell according to the first aspect of the invention and/or to a tool according to the second aspect of the invention.

Preferably, the continuous-fiber-reinforced insert is heated before being inserted into the article cavity, in particular with a heating device, in particular to a temperature above or equal to the melting point of a matrix material of the continuous-fiber-reinforced insert.

This can advantageously ensure that the continuous-fiber-reinforced insert can be better reshaped or can be reshaped at all; in particular, this can prevent or reduce the risk of continuous fibers breaking, tearing or other damage during pre-shaping and/or molding.

Furthermore, this makes it possible to achieve an integrally bonded connection between the matrix material of the continuous-fiber-reinforced insert and the molding compound.

Advantageously, heating the continuous-fiber-reinforced insert can also improve the surface quality of the surface of the battery shell adjacent to the continuous-fiber-reinforced insert.

It should be expressly pointed out that according to an alternative embodiment, heating of the continuous-fiber-reinforced insert in the article cavity of the tool is also proposed, in particular with an infrared emitter. Furthermore, it is conceivable that the continuous-fiber-reinforced insert is heated both before and after insertion into the article cavity.

Optionally, the continuous-fiber-reinforced insert is placed on a local elevation of the article cavity when inserted into the article cavity.

This allows the surface contact between the continuous-fiber-reinforced insert and the article cavity to be reduced to a minimum, which can prevent or reduce cooling of the continuous-fiber-reinforced insert.

Preferably, the continuous-fiber-reinforced insert is deposited corresponding to a positioning means when inserted into the article cavity.

Preferably, the continuous-fiber-reinforced insert is placed adjacent to edge stops or within edge stops arranged on both sides within the article cavity.

This can improve the positioning accuracy of the continuous-fiber-reinforced insert within the battery shell, which can also improve the reproducibility during production of the battery shell.

Optionally, the continuous-fiber-reinforced insert is pre-shaped with a preforming tool before the battery shell is molded.

By pre-shaping the continuous-fiber-reinforced insert before inserting it into the opened article cavity or after inserting it into the opened article cavity, the positioning accuracy of the continuous-fiber-reinforced insert in the battery shell can be improved.

It should be expressly noted that the subject matter of the third aspect can advantageously be combined with the subject matter of the preceding aspects of the invention, both individually or cumulatively in any combination.

According to a fourth aspect of the invention, the object is achieved by a battery shell, in particular a battery shell of a traction battery, the battery shell being produced with a tool according to the second aspect of the invention and/or using a method according to the third aspect of the invention.

It is evident that the advantages of a battery shell produced with a tool according to the second aspect of the invention, as described above, and/or a battery shell produced with a method according to the third aspect of the invention, as described above, extend directly to a battery shell produced with a tool according to the second aspect of the invention and/or a battery shell produced with a method according to the third aspect of the invention.

It should be expressly noted that the subject matter of the fourth aspect can advantageously be combined with the subject-matter of the preceding aspects of the invention, both individually and cumulatively in any combination.

According to a fifth aspect of the invention, the object is achieved by a traction battery, in particular a traction battery for a motor vehicle, comprising a battery shell according to the first aspect of the invention and/or a battery shell produced with a tool according to the second aspect of the invention and/or a battery shell produced with a method according to the third aspect of the invention.

In this regard, the following is explained conceptually:
A “motor vehicle” is understood to mean a vehicle driven by a motor. A motor vehicle is preferably not mounted on a rail or at least not permanently track-mounted.

It is evident that the advantages of a battery shell according to the first aspect of the invention, as described above, and/or a battery shell produced with a tool according to the second aspect of the invention, as described above, and/or a battery shell produced with a method according to the third aspect of the invention, as described above, extend directly to a traction battery comprising a battery shell according to the first aspect of the invention and/or a battery shell produced with a tool according to the second aspect of the invention and/or a battery shell produced with a method according to the third aspect of the invention.

It should be expressly noted that the subject-matter of the fifth aspect can advantageously be combined with the subject-matter of the preceding aspects of the invention, both individually and cumulatively in any combination.

According to a sixth aspect of the invention, the object is achieved by a motor vehicle having a battery shell according to the first aspect of the invention and/or a battery shell produced with a tool according to the second aspect of the invention and/or a battery shell produced with a method according to the third aspect of the invention.

It is evident that the advantages of a battery shell according to the first aspect of the invention, as described above, and/or of a battery shell produced with a tool according to the second aspect of the invention, as described above, and/or of a battery shell produced with a method according to the third aspect of the invention, as described above, extend directly to a motor vehicle having a battery shell according to the first aspect of the invention and/or a battery shell produced with a tool according to the second aspect of the invention and/or a battery shell produced with a method according to the third aspect of the invention.

It should be expressly noted that the subject matter of the sixth aspect can advantageously be combined with the subject matter of the preceding aspects of the invention, specifically individually or cumulatively in any combination.

Further advantages, details, and features of the invention can be found below in the described embodiments. In the figures, in detail:

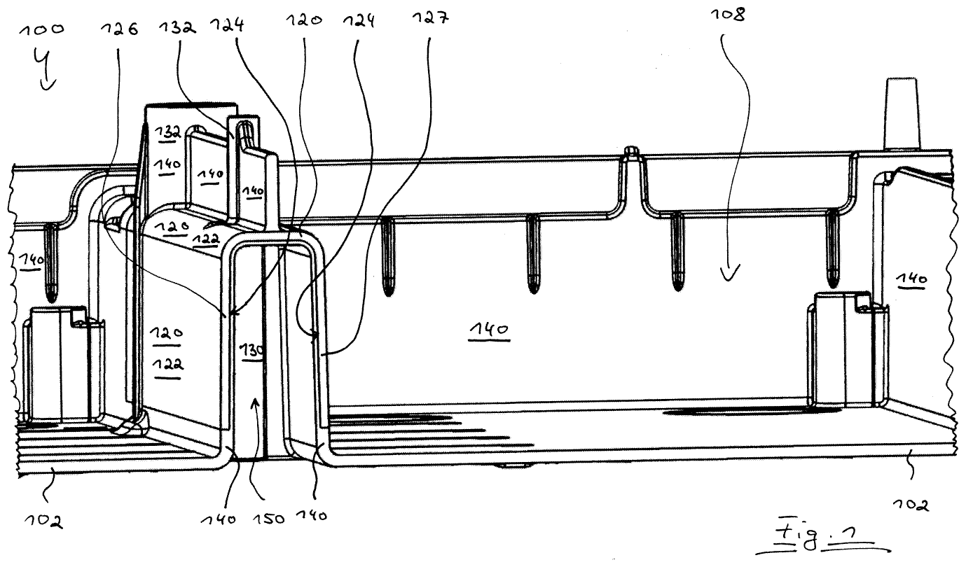

FIG. 1: schematically shows a detail of a first embodiment of a battery shell in perspective view, wherein the battery shell has a sectional view.

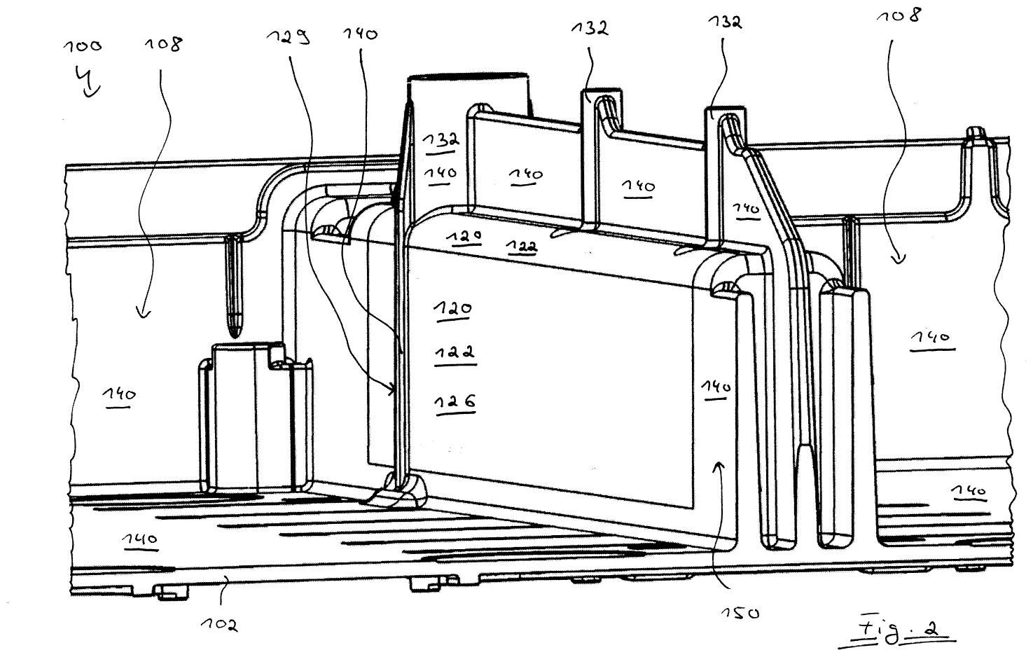

FIG. 2: schematically shows a detail of a second embodiment of a battery shell in perspective view, wherein the battery shell has a sectional view;

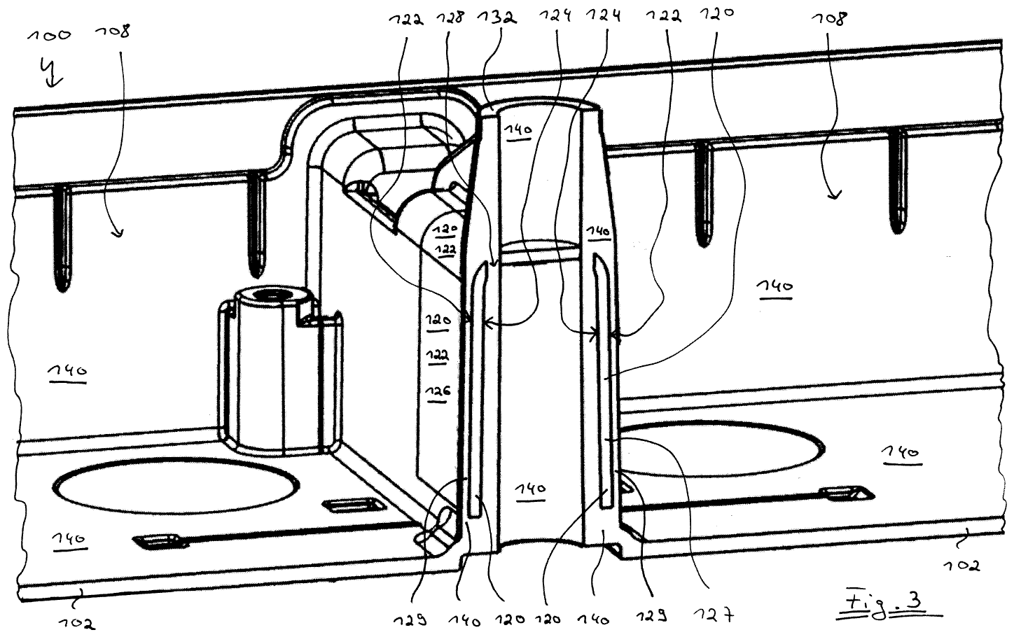

FIG. 3: schematically shows a detail of a third embodiment of a battery shell in perspective view, wherein the battery shell has a sectional view; and

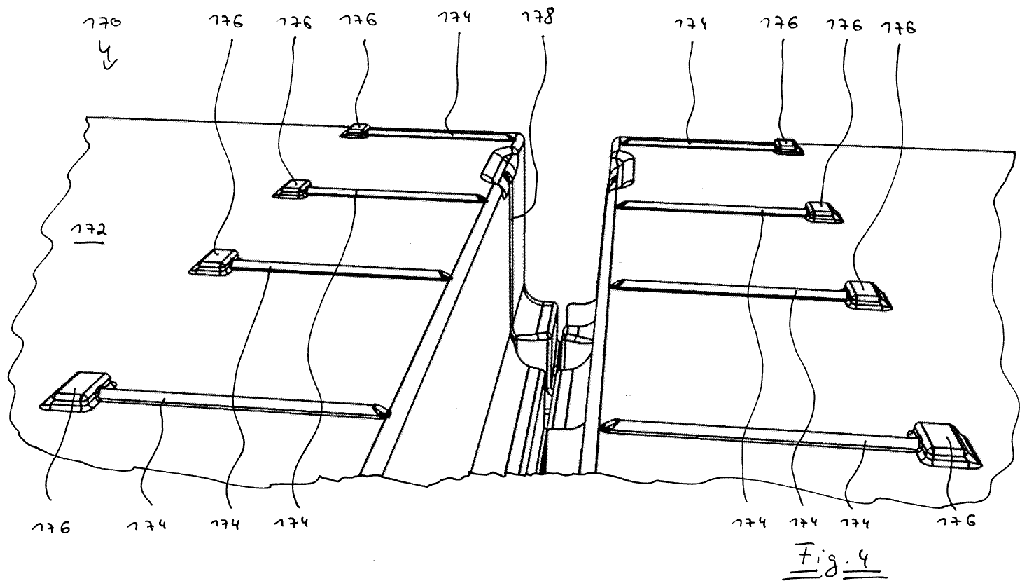

FIG. 4: schematically shows a detail of a tool in perspective view, wherein the tool has a sectional view.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The detail of an embodiment of a battery shell 100 in FIG. 1 has a battery shell 100 consisting of a base 102 and at least one side wall (not shown), wherein the battery shell 100 has an inner side 108 which is designed to accommodate components (not shown) of a designated traction battery (not shown).

The battery shell 100 is molded from a molding compound 140 and a continuous-fiber-reinforced insert 120, wherein the continuous-fiber-reinforced insert 120 has a first surface 122 of which more than or equal to 50% is not overpressed by the molding compound 140. Furthermore, the continuous-fiber-reinforced insert 120 has a second surface 124, which is arranged opposite the first surface 122 and of which more than 95% is overpressed by the molding compound 140.

In the present case, the continuous-fiber-reinforced insert 120 consists of an organosheet, wherein the continuous-fiber-reinforced insert is arranged on the inner side 108 of the battery shell 100, in particular with the first surface 122 of the continuous-fiber-reinforced insert 120 arranged on the inner side 108 of the battery shell 100.

The continuous-fiber-reinforced insert 120 is arranged in an inner stiffening means 150 of the battery shell 100 and does not have geometry that extends flat, but rather a three-dimensional geometry. In particular, the continuous-fiber-reinforced insert 120 which originally had a flat geometry prior to the molding of the battery shell 100 is shaped in such a way that it no longer has a flat geometry after the molding. In other words, the continuous-fiber-reinforced insert 120 protrudes from a flat plane. In other words, the continuous-fiber-reinforced insert 120 is shaped from a single plane.

The continuous-fiber-reinforced insert 120 has, in a cross-section to its main direction of extension, a first leg 126 and a second leg 127, wherein the first leg 126 and the second leg 127 are connected to one another, in particular are directly connected to one another.

The continuous-fiber-reinforced insert 120 comprises with its second surface 124 a transverse rib 130 at least partially. The transverse rib 130 is configured to stiffen the inner stiffening means 150 and thus to stiffen the battery shell 100.

On the inner side 108 of the battery shell 100, between the first leg 126 and the second leg 127 of the continuous-fiber-reinforced insert 120, a functional element 132 is arranged, which is also formed from the molding compound 140.

The insert 120 can have a chamfer. Preferably, the insert 120 has a chamfer that is configured to interact with a flow front of the molding compound 140 during the molding of the battery shell 100, wherein, in particular, a flow pressure of the molding compound 140 advantageously interacts with the chamfer during the molding of the battery shell 100. As a result, it can be achieved that the insert can be reproducibly pressed against an article cavity (not shown) of a tool (not shown) using the flow pressure of the molding compound 140, as a result of which, as a whole, a reproducible arrangement of the insert 120 in the battery shell 100 can be supported and/or the reproducibility of an arrangement of the insert 120 in the battery shell 100 can be improved.

Furthermore, the insert 120 preferably has a chamfer at opposite ends of the insert 120 in a transverse direction to its main direction of extension. This can assist in arranging the insert 120 on the inner side 108 of the battery shell 100.

The detail of an embodiment of a battery shell 100 in FIG. 2 has a battery shell 100 with a base 102 and enables a side view of a continuous-fiber-reinforced insert 120 arranged in an inner stiffening means 150. In particular, the perspective view allows a better view of the first surface 122 of the first leg 126 of the continuous-fiber-reinforced insert 120.

On the upper side of the continuous-fiber-reinforced insert 120, at least three functional elements 132 are arranged, which are likewise formed from the molding compound 140 and of which at least two represent connecting elements 132 which are designed to connect the battery shell 100 to further components (not shown) of a designated traction battery (not shown).

The detail of an embodiment of a battery shell 100 in FIG. 3 has a battery shell 100 with a base 102 and an inner stiffening means 150, which is shown in a section through a functional element 132. Furthermore, the plane of section (not designated) runs through a rib 129 of the inner stiffening means 150.

Between the first leg 126 and the second leg 127 of the continuous-fiber-reinforced insert 120, the latter has a recess 128. Among other things, the recess 128 in the continuous-fiber-reinforced insert 120 enables the molding compound 140 to flow through it in an advantageous manner during the molding (not shown) of the battery shell 100. Thus, molding compound 140 can reach and form the region of the functional element 132, which region is also formed from molding compound 140, during the molding (not shown) of the battery shell 100 by means of an extrusion process.

The rib 129 formed on both sides of the continuous-fiber-reinforced insert 120 can increase the rigidity of the inner stiffening element 150. During the molding of the battery shell 100, molding compound 140 can flow into the region of the functional element 132 and help to mold the functional element 132.

The detail of a tool 170 in FIG. 4 shows a view into an opened tool 170, which is set up with its article cavity 172 for molding a battery shell (not shown). The tool 170 is shown in section on the rear side.

The tool 170 has a plurality of mutually corresponding local elevations 174 which are configured for the partial depositing of a continuous-fiber-reinforced insert (not shown) in the article cavity 172. In this case, a continuous-fiber-reinforced insert (not shown), which may have a flat geometry before the battery shell (not shown) is molded, can be placed on the local elevations 174. Since the continuous-fiber-reinforced insert (not shown) has an inherent rigidity, it touches the tool 170 after being deposited at least predominantly only at the local elevations 174, whereby cooling of the continuous-fiber-reinforced insert (not shown) can be reduced.

For the reproducible positioning of the continuous-fiber-reinforced insert (not shown) in the tool 170, the latter additionally has positioning means 176 which are arranged corresponding to the local elevations 174.

Furthermore, the tool 170 has a local depression 178 in the article cavity 172, wherein the local depression 178 is configured to form a rib (not shown) of the battery shell (not shown).

### LIST OF REFERENCE SIGNS

100 Battery shell
102 Base
108 Inner side
120 Continuous-fiber-reinforced insert
122 First surface
124 Second surface
126 First leg
127 Second leg
128 Recess
129 Rib
130 Transverse rib
132 Functional element
140 Molding compound
150 Inner stiffening means
170 Tool
172 Article cavity
174 Local elevation
176 Positioning means
178 Local depression

1. A battery shell, in particular a battery shell of a traction battery, wherein the battery shell has a base and at least four side walls, wherein the battery shell has an inner side and an outer side,
wherein the battery shell is molded from a molding compound made of plastic and from a continuous-fiber-reinforced insert,
wherein the continuous-fiber-reinforced insert has a first surface of which more than or equal to 50%, preferably more than or equal to 60%, and particularly preferably more than or equal to 75% is not overpressed by the molding compound,
wherein the continuous-fiber-reinforced insert has a second surface, which is arranged opposite the first surface and of which more than 95%, preferably more than or equal to 97%, and particularly preferably more than or equal to 99%, is overpressed by the molding compound,
wherein the molding compound is mixed with a fiber material.

2. The battery shell of claim 1, wherein the continuous-fiber-reinforced insert comprises an organosheet and/or a tape fabric.

3. The battery shell of claim 1, wherein the continuous-fiber-reinforced insert is shaped from a single plane.

4. The battery shell of claim 1, wherein the continuous-fiber-reinforced insert has at least a first leg and a second leg in a cross-section to its main direction of extension, wherein the first leg and the second leg are connected to one another, wherein the first leg and the second leg have an angle of less than or equal to 100° to one another, preferably an angle of less than or equal to 50° and particularly preferably an angle of less than or equal to 30°.

5. The battery shell of claim 4, wherein the first leg and the second leg have an angle of greater than or equal to 5° to one another, preferably an angle of greater than or equal to 10°, and particularly preferably an angle of greater than or equal to 15°.

6. The battery shell of claim 1, wherein the continuous-fiber-reinforced insert has at least one recess.

7. The battery shell of claim 1, wherein the continuous-fiber-reinforced insert has a rib immediately adjacent to its first surface.

8. The battery shell of claim 1, wherein the continuous-fiber-reinforced insert with its second surface at least partially comprises a transverse rib.

9. The battery shell of claim 1, wherein the continuous-fiber-reinforced insert is arranged in an inner stiffening means of the battery shell.

10. The battery shell of claim 1, wherein the continuous-fiber-reinforced insert is arranged on the inner side of the battery shell, in particular with the first surface of the continuous-fiber-reinforced insert arranged on the inner side of the battery shell.

11. The battery shell of claim 1, wherein the battery shell is molded using a compression-molding process.

12. The battery shell of claim 1, wherein the battery shell has at least one linearly extending indentation, preferably a linearly extending indentation on the inner side of the base.

13. The battery shell of claim 1, wherein the insert has a chamfer, preferably two chamfers.

14. A tool for producing a battery shell of claim 1, wherein the tool is a compression mold, wherein the tool forms an article cavity, wherein the tool preferably has a means for filling the article cavity with a molding compound.

15. The tool of claim 14, wherein the tool has a local elevation in the article cavity, in particular a plurality of mutually corresponding local elevations, which are designed for the partial surface deposit of the continuous-fiber-reinforced insert in the article cavity.

16. The tool of claim 14, wherein the tool has a positioning means which is configured to position the continuous-fiber-reinforced insert in the tool.

17. The tool of claim 14, wherein the tool has a temperature-control system for controlling the temperature of the tool.

18. The tool of claim 14, wherein the tool has a preforming tool, wherein the preforming tool is configured to preform the continuous-fiber-reinforced insert.

19. The tool of claim 14, wherein the tool has a local depression in the article cavity, wherein the local depression is configured to form a rib of the battery shell.

20. The tool of claim 14, wherein the tool has a transverse rib recess, wherein the transverse rib recess is configured to form a transverse rib of the battery shell.

21. The tool of claim 14, wherein the tool has a manipulator or is configured to interact with a manipulator, wherein the manipulator is configured to deposit the continuous-fiber-reinforced insert in the article cavity.

22. The tool of claim 14, wherein the tool has a heating device or is designed to interact with a heating device, wherein the heating device is configured to heat the continuous-fiber-reinforced insert.

23. A method for producing a battery shell of claim 1 using a tool wherein the tool is a compression mold, wherein the tool forms an article cavity, wherein the tool preferably has a means for filling the article cavity with a molding compound, wherein the method for producing the battery shell comprises the following steps:
a) inserting the continuous-fiber-reinforced insert into the opened article cavity;
b) introducing the molding compound into the article cavity;
c) forming the battery shell; and
d) demolding the battery shell (100).

24. The method of claim 23, wherein the continuous-fiber-reinforced insert is heated before being inserted into the article cavity, in particular with a heating device, in particular to a temperature above or equal to the melting point of a matrix material of the continuous-fiber-reinforced insert.

25. The method of claim 23, wherein the continuous-fiber-reinforced insert is deposited on a local elevation of the article cavity when it is inserted into the article cavity.

26. The method of claim 23, wherein the continuous-fiber-reinforced insert is deposited corresponding to a positioning means when inserted into the article cavity.

27. The method of claim 23, wherein the continuous-fiber-reinforced insert is pre-shaped with a preforming tool before the battery shell is molded.

28. (canceled)

29. A traction battery, in particular a traction battery for a motor vehicle, comprising a battery shell of claim 1.

30. A motor vehicle comprising a battery shell of claim 1.
